(19) United States
(12) Patent Application Publication
(10) Pub. No.: US 2017/0088096 A1
(43) Pub. Date: Mar. 30, 2017

(54) SEAT SAFETY APPARATUS WITH A RESILIENT SENSOR

(71) Applicant: INTEL IP CORPORATION, Santa Clara, CA (US)

(72) Inventors: ENNO LUEBBERS, Munich (DE); CAGRI TANRIOVER, Istanbul (TR)

(73) Assignee: INTEL IP CORPORATION, Santa Clara, CA (US)

(21) Appl. No.: 14/864,652

(22) Filed: Sep. 24, 2015

(51) Int. Cl. B60R 22/48; B60R 22/12

(52) U.S. Cl. CPC B60R 22/48; B60R 22/12; B60R 2022/4841; B60R 2022/4866

(57) ABSTRACT

A seat safety apparatus, comprising a lap harness including a lap harness belt segment and at least one lap harness sensor connected with the lap harness belt segment; the lap harness sensor formed of an electrically conductive material having an electrical resistance variable as a function of strain of the lap harness sensor wherein, in response to a change in strain of the electrically conductive material of the lap harness sensor, the electrical resistance of the electrically conductive material of the lap harness sensor changes; wherein the electrically conductive material of the lap harness sensor provides an electrical resistance in an electrical circuit of the seat safety apparatus; and wherein, in response to electrical power provided to the electrical circuit, the lap harness sensor provides a lap harness sensor output which changes as the electrical resistance of the electrically conductive material of the lap harness sensor changes.

### FIELD

The present disclosure relates to a seat safety apparatus, and more particularly to a seat safety apparatus comprising a lap harness, and which may also include a sash harness.

### BACKGROUND

Harness belts of transportation vehicles, which may also be referred to as safety belts or seat belts, are safety devices designed to secure an occupant of the transportation vehicle in a seat, particularly against harmful movements which may result from a collision of the vehicle with another object or other sudden stop of the vehicle. More particularly, the harness belt reduces a likelihood of serious injury of the occupant arising from secondary impacts within the vehicle or being thrown from the vehicle. The harness belt also assists in maintaining a proper position of the seat occupant for proper benefit of other safety devices such as air bags.

### FIGURES

The features of this disclosure, and the manner of attaining them, will become more apparent and better understood by reference to the following description of embodiments described herein taken in conjunction with the accompanying drawings, wherein:

FIG. 1 is a front (plan) view of a seat safety apparatus according to the present disclosure, and further including a seat occupant within a seat of a transportation vehicle;

FIG. 2 is a front (plan) view of a seat safety apparatus according to FIG. 1 with additional detail, and the seat occupant, seat and transportation vehicle removed;

FIG. 3A is a front (plan) view of a lap harness of the seat safety apparatus according to FIG. 1;

FIG. 3B is a front (plan) view of an alternative lap harness of the seat safety apparatus according to FIG. 1;

FIG. 4A is a perspective view of an alternative lap harness of the seat safety apparatus according to FIG. 1; and

FIG. 4B is a side view of the lap harness of the seat safety apparatus according to FIG. 4.

### DETAILED DESCRIPTION

It may be appreciated that the present disclosure is not limited in its application to the details of construction and the arrangement of components set forth in the following description or illustrated in the drawings. The disclosure provided herein may be capable of other embodiments and of being practiced or being carried out in various ways. Also, it may be appreciated that the phraseology and terminology used herein is for the purpose of description and should not be regarded as limiting as such may be understood by one of skill in the art.

Harness belts are an important and ubiquitous safety feature in transportation vehicles, such as land transportation vehicles (e.g. motor vehicle such as an automobile), water transportation vehicles (e.g. motor vehicle such as a boat) or air transportation vehicles (e.g. motor vehicle such as a plane or helicopter). Such belts are configured to restrict harmful movement of an occupant of a vehicle seat during a vehicle collision or other sudden stop. While there are some actuation components present in current harness belt implementations (i.e. belt tensioner), and some limited sensing capabilities in the belt buckle to determine open or closed states, the harness belt itself generally is provided in the form of a tear-resistant fabric with no sensing components.

The present disclosure improves the scope and features of this critical safety component by integrating resilient (stretchable) sensors into the harness belts of a transportation vehicle to determine safety related status states for the belt and/or occupant during normal vehicle use, as well as during or after a vehicle collision or other sudden stop, without compromising existing safety benefits or comfort of the harness belt in the vehicle. The harness belts equipped with such sensors may not only provide information related to the integrity and the correct use of the belts, but may also provide valuable information on the status of seat occupants after a vehicle collision or other sudden stop of the vehicle.

For example, such safety related status states while the vehicle is running during normal vehicle use may include whether the belt is being worn properly by a seat occupant, which may include whether the belt has a proper level of tension or whether the belt is properly arranged/orientated (e.g. is not twisted), as well as whether the integrity of the belt has been compromised (e.g.as a result of a vehicle collision, or wear and tear). Safety related status states during a vehicle collision may include how severe of a force was placed upon a seat occupant during a vehicle collision. Safety related status states after a vehicle collision may include whether a seat occupant is breathing after the vehicle collision.

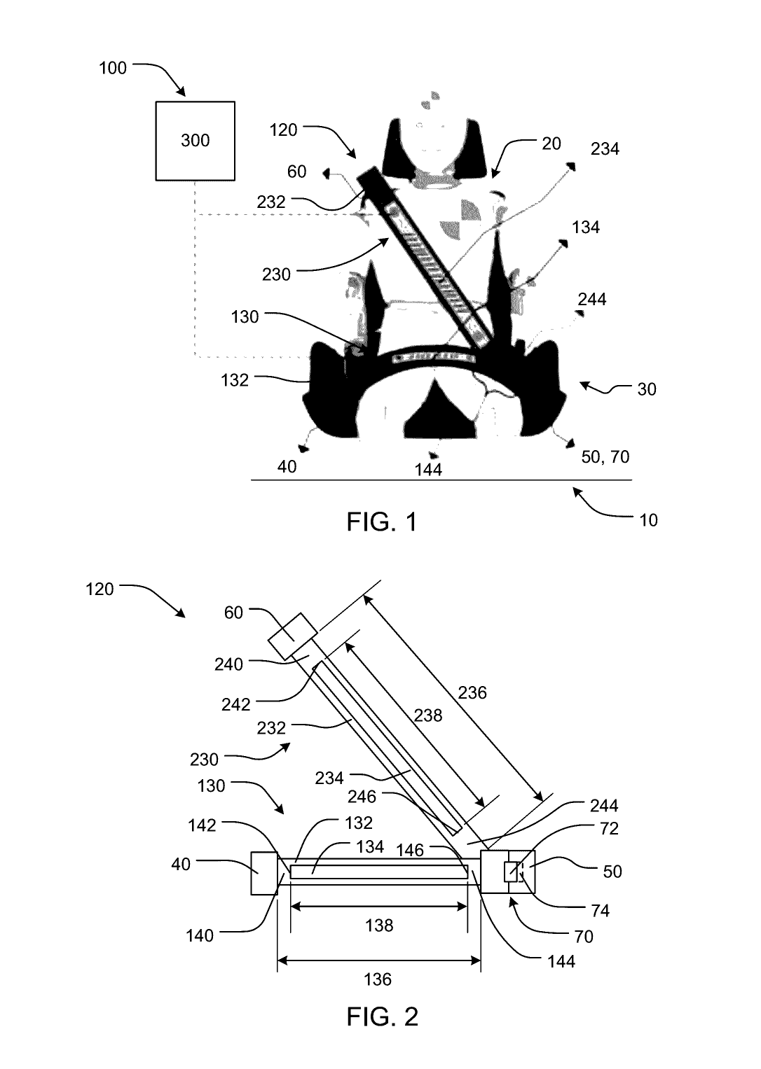

Referring now to FIGS. 1 and 2, there is shown a safety apparatus, and more particularly a seat safety apparatus 100, which may be a seat safety apparatus 100 of a transportation vehicle 10. The transportation vehicle 10 may be a land transportation vehicle (e.g. motor vehicle such as an automobile), a water transportation vehicle (e.g. motor vehicle such as a boat) or an air transportation vehicle (e.g. motor vehicle such as a plane or helicopter).

Seat safety apparatus 100 is configured to secure/restrain an occupant 20 of a seat 30, such as a seat 30 of the transportation vehicle 10. Seat safety apparatus 100 comprises a seat harness 120 (which may also be referred to as a safety harness). Seat harness 120 may be, for example, a two-point seat harness, a three-point seat harness, a four-point seat harness, a five-point seat harness, a six-point seat harness or a seven-point seat harness.

As shown, seat harness 120 comprises a three-point seat harness. The three-point seat harness 120 may comprise a lap harness 130 and a sash harness 230.

Lap harness 130 may be orientated and arranged to extend across the lap (abdomen) and hips of the seated occupant 20, from a first anchor 40 located adjacent one end of the lap harness 130 to a second anchor 50 located adjacent the opposing end of the lap harness 130.

Sash harness 230 may be orientated and arranged to extend diagonally across the thorax of the seated occupant 20, from a shoulder of the occupant 20 to an opposing hip of the occupant 20. Sash harness 230 may extend from the second anchor 50 located adjacent one end of the sash harness 230 to a third anchor 60 located adjacent the opposing end of the sash harness 230. The first anchor 40 and/or the third anchor 60 may each include a harness belt retractor.

In addition to the foregoing, seat safety apparatus 100 may further comprise at least one buckle 70, which may comprise a buckle latch 72 and a buckle latch receptacle 74, to fasten and unfasten the seat harness 120, in addition to the retractor(s) to retract the lap harness 130 and/or the sash harness 230.

Lap harness 130 may comprise at least one lap harness belt segment 132, while sash harness 230 may comprise at least one sash harness belt segment 232. The two belt segments 132, 232 may be provided as part of a single piece belt, or two separate belts.

As best shown in FIG. 1, lap harness 130 further comprises a resilient lap (pelvis) harness sensor 134 connected with the lap harness belt segment 132. Lap harness sensor 134 may be understood to be resilient by being able to recoil or spring back, or otherwise recover from a strained shape to an initial shape (at a lower or no strain) without substantial permanent deformation (e.g. less than 10% and more particularly less than 5% and even more particularly less than 1%), such as by being formed of a plastic elastomer, after release of a strain placed thereon.

Lap harness sensor 134 extends longitudinally along a longitudinal length of the lap harness belt segment 132, preferably with a longitudinal length which covers a substantial portion of each hip. More particularly, the lap harness sensor 134 extends longitudinally along a medial longitudinal length region 138 of an overall longitudinal length 136 of the lap harness belt segment 132 defined between the first anchor 40 and the buckle 70 or second anchor 50 (in the event buckle 70 is not present).

The longitudinal length of the lap harness sensor 134 preferably does not extend longitudinally along the overall longitudinal length 136 of the lap harness belt segment 132, but rather solely along the medial longitudinal length region 138 of the overall longitudinal length 136 of the lap harness belt segment 132. The medial longitudinal length region 138 of the overall longitudinal length 136 of the lap harness belt segment 132 may be preferably in a range of 50-95% of the overall longitudinal length 136 of the lap harness belt segment 132. More particularly, the medial longitudinal length region 138 of the overall longitudinal length 136 of the lap harness belt segment 132 may be preferably in a range of 65-90% of the overall longitudinal length 136 of the lap harness belt segment 132.

In the foregoing manner, a distal (clearance) longitudinal end region 140 of the lap harness belt segment 132 is provided between one terminal longitudinal end 142 of the lap harness sensor 134 and the first anchor 40, while another opposing distal (clearance) longitudinal end region 144 is provided between the opposing terminal longitudinal end 146 of the lap harness sensor 134 and the buckle 70 or second anchor 50 (in the event buckle 70 is not present).

Clearance end regions 140, 144 are provided adjacent each end 142, 146 of the lap harness belt segment 132, which do not include lap harness sensor 134, to enable for potentially more accurate lap harness sensor output values (e.g. indicative of force and corresponding strain applied to the lap harness sensor 134) to be obtained from the lap harness sensor 134. For example, if the terminal longitudinal end 146 of the lap harness sensor 134 extended to buckle 70, the lap harness sensor 134 may be expected to fold within the buckle 70 and consequently lap harness sensor output values from the lap harness sensor 134 obtained at or adjacent the buckle 70 may be expected to be subject to unwanted noise that will interfere with lap harness sensor output values of interest.

As shown in FIG. 1, sash harness 230 further comprises a resilient sash (torso) harness sensor 234, which may be identical in structure and operation to the lap harness sensor 234. As with lap harness sensor 134, sash harness sensor 234 may be understood to be resilient by being able to recoil or spring back into shape without substantial permanent deformation after being stretched (strained) from its pre-stretched shape.

Sash harness sensor 234 extends longitudinally along a longitudinal length of the sash harness belt segment 232, preferably with a longitudinal length which covers a substantial portion of the torso. More particularly, the sash harness sensor 234 extends longitudinally along a medial longitudinal length region 238 of an overall longitudinal length 236 of the sash harness belt segment 232 defined between the third anchor 60 and the buckle 70 or second anchor 50 (in the event buckle 70 is not present).

Similar to the lap harness sensor 134, the longitudinal length of the sash harness sensor 234 preferably does not extend longitudinally along the overall longitudinal length 236 of the sash harness belt segment 232, but rather solely along the medial longitudinal length region 238 of the overall longitudinal length 236 of the sash harness belt segment 232. The medial longitudinal length region 238 of the overall longitudinal length 236 of the sash harness belt segment 232 may be preferably in a range of 50-95% of the overall longitudinal length 236 of the sash harness belt segment 232. More particularly, the medial longitudinal length region 238 of the overall longitudinal length 236 of the sash harness belt segment 232 may be preferably in a range of 65-90% of the overall longitudinal length 236 of the lap harness belt segment 232.

Also similar to the lap harness sensor 134, in the foregoing manner, a distal (clearance) longitudinal end region 240 of the sash harness belt segment 232 is provided between one terminal longitudinal end 242 of the sash harness sensor 234 and the third anchor 60, while another opposing distal (clearance) longitudinal end region 244 is provided between the opposing terminal longitudinal end 246 of the sash harness sensor 234 and the buckle 70 or second anchor 50 (in the event buckle 70 is not present).

Clearance end regions 240, 244 are provided adjacent each end 242, 246 of the sash harness sensor 234, which do not include sash harness sensor 234, to enable for potentially more accurate sash harness sensor output values (e.g. indicative of force and corresponding strain applied to the sash harness sensor 234) to be obtained by the sash harness sensor 234. Again, for example, if the terminal longitudinal end 246 of the sash harness sensor 234 extended to buckle 70, the sash harness sensor 234 may be expected to fold within the buckle 70 and consequently sash harness sensor output values from the sash harness sensor 234 obtained at or adjacent the buckle 70 may be expected to be subject to unwanted noise that will interfere with the sash harness sensor output values of interest.

In light of the above, it should be clear that the lap harness sensor 134 is positioned on the lap harness belt segment 132 to capture sensor output values from the pelvic (including hip and leg) region of a seat occupant, while the sash harness sensor 234 is positioned on the sash harness belt segment 232 to sensor output values from the thoracic region of a seat occupant. It should also be understood that while only one lap harness sensor 134 and one sash harness sensor 234 may be shown for a given lap harness 130 or sash harness 230, a plurality of lap harness sensors 134 and/or a plurality of and sash harness sensors 234 may also be used, for example, to add redundancy to the sensing hardware or for different locations thereby increasing the reliability of detection of the strain in different parts of seat safety apparatus 100.

In addition to the foregoing, seat safety apparatus comprises an electronic control unit (ECU) 300. Broadly, the seat safety apparatus ECU 300 is electrically connected with the lap harness sensor 134 such that the lap harness sensor output is receivable by the seat safety apparatus ECU 300, as well as electrically connected with the sash harness sensor 234 such that the sash harness sensor output is receivable by the seat safety apparatus ECU 300. In response to a lap sensor output received by the seat safety apparatus ECU 300 from the lap harness sensor 134, the seat safety apparatus ECU 300 may provide a warning notification related to strain occurring on the lap harness sensor 134. Similarly, in response to a sash sensor output received by the seat safety apparatus ECU 300 from the sash harness sensor 234, the seat safety apparatus ECU 300 may provide a warning notification related to strain occurring on the sash harness sensor 234.

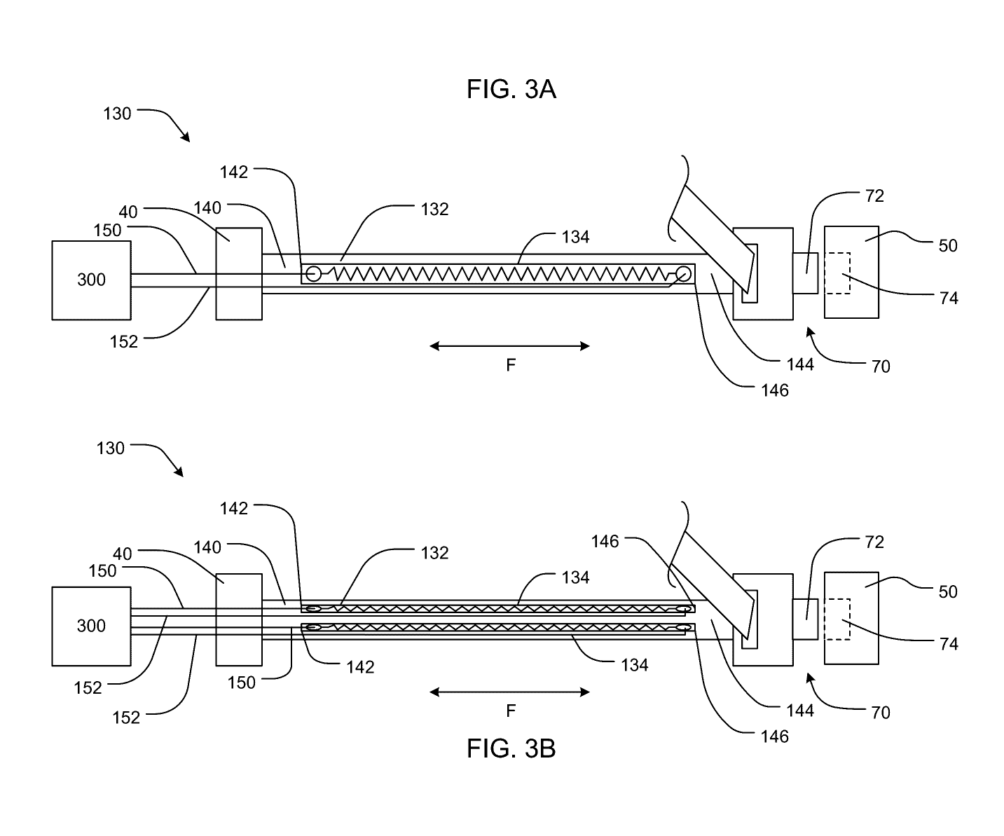

The seat safety apparatus ECU 300 is used for receiving sensor output values, particularly electrical signals, from lap harness sensor 134, as well as sash harness sensor 234. Seat safety apparatus ECU 300 is configured to receive lap harness sensor output values and sash harness sensor output values transmitted from both lap harness sensor 134 and sash harness sensor 234, respectively, which may both comprise voltage signals. The electrical signals may be raw (unconditioned) voltage signals, or the signals may be conditioned by the sensor 134, 234 (e.g. amplified, filtered, etc.). The seat safety apparatus ECU 300 may include one or more algorithms which correlate an output voltage signal of the lap harness sensor 134, as well as an output voltage signal of the sash harness sensor 234, to a corresponding strain and/or force applied to each sensor 134, 234, respectively, resulting from a force (e.g. tensile force F of FIGS. 3A/3B) being applied to each sensor 134, 234.

Alternatively, the electronic control unit 300 may include one or more look-up tables which correlate an output voltage signal of the lap harness sensor 134, as well as an output voltage signal of the sash harness sensor 234, to a corresponding strain and/or force applied to each sensor 134, 234, respectively.

It should be understood that while the electronic control unit 300 is shown as being separate from sensors 134, 234, any or all of the structure and functions of the electronic control unit 300 may be integrated into each of the sensors 134, 234 depending on constraints (e.g. size, cost, etc.)

Both the resilient lap harness sensor 134 and the resilient sash harness sensor 234 may be formed of an electrically conductive material having an electrical resistance which is variable as a function of strain of the sensor 134, 234. More particularly, in response to a change in strain of the electrically conductive material of the lap harness sensor 134 or the sash harness sensor 234, the electrical resistance of the electrically conductive material of the sensor 134, 144 changes.

With regards to operation, as shown by the figures, the electrically conductive material of the lap harness sensor 134, as well as the sash harness sensor 144, provides an electrical resistance (shown with a resistor symbol for purposes of illustration) in an electrical circuit of the seat safety apparatus 100. In response to electrical power provided to the electrical circuit, the lap harness sensor 134 provides a lap harness sensor output (e.g. voltage signal) which changes as the electrical resistance of the electrically conductive material of the lap harness sensor 134 changes. Similarly, in response to electrical power provided to the electrical circuit, the sash harness sensor 234 provides a sash harness sensor output (e.g. voltage signal) which changes as the electrical resistance of the electrically conductive material of the sash harness sensor 234 changes.

In light of the above, it should be understood that the seat safety apparatus 100 may be configured such that all sensor output values from each seat 30 within the transportation vehicle 10 may be received and processed by the seat safety apparatus ECU 300. The seat safety apparatus ECU 300 may be a stand-alone unit, or integrated with another vehicle control unit in the transportation vehicle, such as the engine control unit. The seat safety apparatus ECU 300 may be interfaced to the transportation vehicle's control center via wired or wireless communication. Depending on the built in wireless capabilities of the transportation vehicle 10, data and information from the seat safety apparatus ECU 300 may be transmitted to a remote computer over a computer network.

Referring now to FIG. 3A, there is shown a close-up view of lap harness 130 with lap harness belt segment 132 and lap harness sensor 134. While only the lap harness 130 with lap harness belt segment 132 and lap harness sensor 134 is shown, it should be understood that the sash harness 230 with sash harness belt segment 232 and sash harness sensor 234 may have the same structure and operate in the same manner as the lap harness belt segment 132 and lap harness sensor 134.

The lap harness sensor 134, and more particularly the electrically conductive material of the lap harness sensor 134 may be mechanically and/or adhesively connected to the lap harness belt segment 132.

In one construction, the electrically conductive material of the lap harness sensor 134 may be mechanically connected to the woven fabric of the lap harness belt segment 132 by being woven into the woven fabric of the lap harness belt segment 132. More particularly, the electrically conductive material of the lap harness sensor 134 comprises resilient electrically conductive fibers which are woven into the woven fabric of the lap harness belt segment 132. The electrically conductive fibers may comprise a plastic composition, such as a thermoset or thermoplastic composition, which comprises at least one electrically conductive polymer, with or without electrically conductive particles (e.g. carbon such as carbon black, silver or other metals) dispersed therein, or at least one non-electrically conductive polymer (e.g. polyester-polyurethane copolymer) with electrically conductive particles dispersed therein. Such a construction provides a benefit of seamless integration.

For example, the electrically conductive fibers may be formed of a plastic elastomer filed with electrically conductive particles. As used herein, an elastomer may be characterized as a material that has an elongation at 23° C. of at least 100%, and which, after being stretched to twice its original length and being held at such for one minute, may recover in a range of 50% to 100% within one minute after release from the stress. More particularly, the elastomer may recover in a range of 75% to 100% within one minute after release from the stress, and even more particularly recover in a range of 90% to 100% within one minute after release from the stress. When the fibers are strained, the cross-sectional area of the fibers may decrease, causing the electrical resistance of the fibers to change and hence the voltage output across the fibers.

In another construction, the electrically conductive material of the lap harness sensor 134 may be adhesively connected to the woven fabric of the lap harness belt segment 132 by being formed in situ (e.g. sprayed) on to the lap harness belt segment 132 to form a resilient electrically conductive coating which adhesively bonds to the woven fabric of the lap harness belt segment 132. The electrically conductive coating may comprise a plastic composition, such as a thermoset or thermoplastic composition, which comprises at least one electrically conductive polymer, with or without electrically conductive particles dispersed therein, or at least one non-electrically conductive polymer (e.g. polyester-polyurethane copolymer) with electrically conductive particles dispersed therein.

For example, the electrically conductive coating may be formed of a plastic elastomer filed with electrically conductive particles. When the coating is strained, the cross-sectional area of the coating may decrease, causing the electrical resistance of the coating to change and hence the voltage output across the coating.

In another construction, the electrically conductive material of the lap harness sensor 134 may be in a form of a pre-formed resilient electrically conductive elongated strip which may be mechanically connected to the woven fabric of the lap harness belt segment 132 by at least one row of stitches. Alternatively, the electrically conductive elongated strip which may be adhesively connected to the woven fabric of the lap harness belt segment 132 by an adhesive composition disposed between the electrically conductive elongated strip and the lap harness belt segment 132. Alternatively, the electrically conductive elongated strip which may be adhesively connected to the woven fabric of the lap harness belt segment 132 by being welded to the lap harness belt segment 132.

In certain constructions, the electrically conductive elongated strip may comprise a resilient electrically conductive fabric, such as a knitted fabric, with electrically conductive fibers. The electrically conductive elongated strip, including the electrically conductive fibers, may comprise a plastic composition, such as a thermoset or thermoplastic composition, which comprises at least one electrically conductive polymer, with or without electrically conductive particles dispersed therein, or at least one non-electrically conductive polymer (e.g. polyester-polyurethane copolymer) with electrically conductive particles dispersed therein.

For example, the electrically conductive strip may be formed of a plastic elastomer filed with electrically conductive particles. When the strip is strained, the cross-sectional area of the strip may decrease, causing the electrical resistance of the strip to change and hence the voltage output across the coating. The strip may be formed of an elastomer such as rubber, which may contain carbon black.

In another construction, the electrically conductive material of the lap harness sensor 134 may be in a form of an electrically conductive coating, as set forth above, disposed on a resilient electrically conductive or electrically non-conductive substrate. The resilient substrate may be a knitted fabric formed of fibers made of a plastic elastomer or other plastic composition,

The terminal longitudinal end 142 of lap harness sensor 134 may be mechanically and electrically coupled to a first electrical conductor 150, which is also mechanically and electrically coupled to seat safety apparatus ECU 300 to establish electrical communication therebetween. Similarly, the opposing terminal longitudinal end 146 of lap harness sensor 134 may be mechanically and electrically coupled to a second electrical conductor 152, which is also mechanically and electrically coupled to seat safety apparatus ECU 300 to establish electrical communication therebetween and form a closed electrical circuit. Similar to the lap harness sensor 134, the first electrical conductor 150 and the second electrical conductor 152 may be formed of an electrically conductive material (e.g. fibers of a fabric), which may also be woven in to the lap harness belt segment 132 as suitable. As may be understood, the number of electrical conductors 150, 152 needed will be a function of the number of the sensors 134, 234 used in the transportation vehicle 10. For example, each sensor 134, 234 may be individually coupled to the seat safety apparatus ECU 300 with its own separate electrical conductors 150, 152. Alternatively, it may be desirable to use two electrical conductors 150, 152 which are electrically coupled to a plurality of sensors, such as if the sensors where wired in series.

FIG. 3B shows lap harness belt segment 132 with two lap harness sensors 134, as opposed to one lap harness sensor 134 shown in FIG. 3A.

Although the integration of lap harness sensor 134 with lap harness belt segment 132 as shown in FIGS. 3A/3B may be seamless when such is woven into the lap harness belt segment 132, integration of the lap harness sensor 134 into the fabric of the lap harness belt segment 132 may be expected to limit the dynamic range of the lap harness sensor 134, particularly given the lap harness belt segment 132 is made of a woven fabric (e.g. nylon/polyester) having a low degree of stretch under load. Such a limitation may adversely affect its output response and the detection capability.

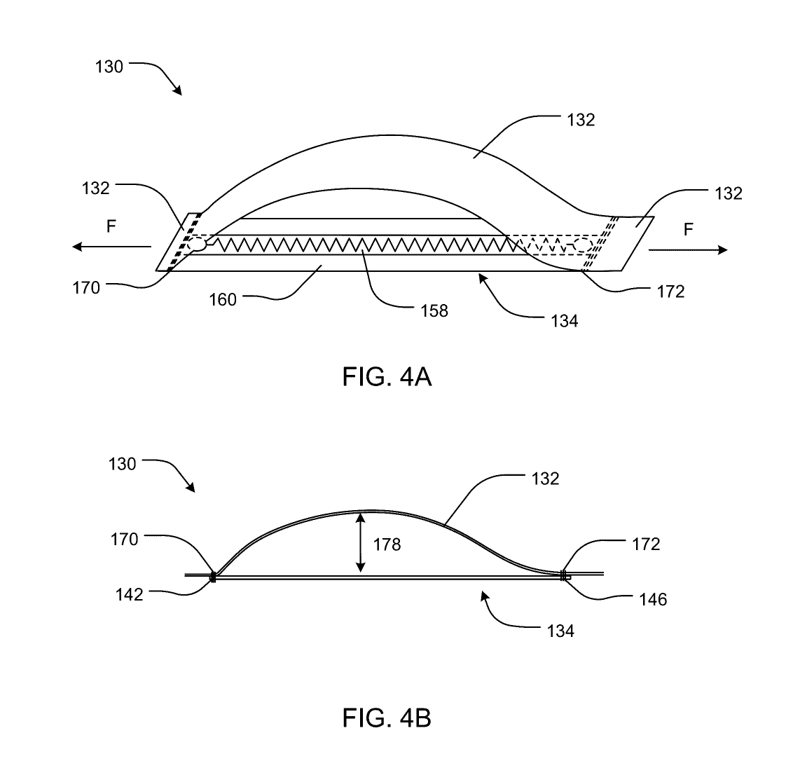

An alternative construction of a lap harness 130 in shown in FIGS. 4A and 4B, in which is shown a close-up view of lap harness 130 with lap harness belt segment 132 and lap harness sensor 134. Again, while only the lap harness 130 with lap harness belt segment 132 and lap harness sensor 134 is shown, it should be understood that the sash harness 230 with sash harness belt segment 232 and sash harness sensor 234 may have the same construction and operation.

As shown in FIGS. 4A and 4B, lap harness sensor 134 is integrated with lap harness belt segment 132. As shown, lap harness sensor 134 includes a strip of electrically conductive coating 158 disposed on an elongated, resilient (stretchable) substrate 160, which may be a fabric such as a knitted fabric (e.g. Spandex)

As shown, similar to the prior embodiment, the lap harness sensor 134 extends longitudinally along the lap harness belt segment 132, and has opposing first and second longitudinal ends 142, 146.

As shown, the lap harness sensor 134 and lap harness belt segment 132 are only connected at a first connection location 170 adjacent terminal longitudinal end 142 of the lap harness sensor 134 and a second connection location 172 adjacent terminal longitudinal end 146 of the lap harness sensor 134. The first and second connection locations 170, 172 may be provided by one or more rows of stitches extending across the width of the lap harness belt segment 132 and the lap harness sensor 134.

Furthermore, as shown, the longitudinal length of the lap harness sensor 134 between the first and second connection locations 170, 172 is less than the longitudinal length of the lap harness belt segment 132 between the first and second connection locations 170, 172.

In FIGS. 4A and 4B, when lap harness belt segment 132 and the resilient substrate 160 are at a rest condition (i.e. unstrained), the longitudinal length of the resilient substrate 160 between first connection location 170 and second connection location 172 is less than the longitudinal length of lap harness belt segment 132 between first connection location 170 and second connection location 172.

Thereafter, when a tension force F is applied to the lap harness 130, the resilient substrate 160 will stretch in tension and the distance of the gap 178 between the lap harness belt segment 132 and the resilient substrate 160 will decrease. Gap 178 is a measure of how much the dynamic range of the lap harness sensor 134 may be extended (i.e. as gap 178 gets larger the dynamic range gets bigger). Of course, the upper limit of gap 178 will also depend on the maximum stretch level of the lap harness sensor 134.

Unlike the embodiments of FIGS. 3A/3B, the embodiment of the lap harness 130 of FIGS. 4A/4B may not be expected to significantly adversely affect the output response and the detection capability of the lap harness sensor 134. In addition, it may be expected to be easier to customize each lap harness sensor 134 to meet specific requirements related to length, thickness and electrical resistance.

However, while the embodiments of FIGS. 3A/3B, may adversely affect the output response and the detection capability of the lap harness sensor 134, neither the embodiments of FIGS. 3A/3B nor the embodiment of FIGS. 4A/4B are expected to significantly adversely affect the intrinsic strength and the safety of the lap harness 130.

By using a seat harness 120 with a seat safety apparatus 100, including lap harness sensor 134 and/or sash harness sensor 234, a number of safety related concerns related to proper use a seat harness can be addressed.

For example, during vehicle use, seat safety apparatus 100, and more particularly lap harness sensor 134 and/or sash harness sensor 234, may be used to better ensure that the lap harness belt segment 132 and/or sash harness belt segment 232, respectively, are fitted properly to the seat occupant 20 with the requisite level of tension. Once the lap harness 130 and/or sash harness 230 are properly buckled, such may be accomplished by seat safety apparatus ECU 300 being used to determine if the strain resulting from tension force F being placed on the lap harness sensor 134 and/or sash harness sensor 234 is within a predetermined range of suitable strain limits. If the strain resulting from tension force F being placed on the lap harness sensor 134 and/or sash harness sensor 234 is outside the predetermined range of suitable strain limits, particularly by being too low, such would be indicative of the lap harness 130 and/or sash harness 230 being too loose on the occupant 20. Conversely, if the strain resulting from tension force F being placed on the lap harness sensor 134 and/or sash harness sensor 234 is outside the predetermined range of suitable strain limits, particularly by being too high, such would be indicative of the lap harness 130 and/or sash harness 230 being too tight on the occupant 20.

If the seat safety apparatus ECU 300 determines that the strain resulting from tension force F being placed on the lap harness sensor 134 and/or sash harness sensor 234 is not within a predetermined range of suitable strain limits, either as too low or too high, the seat safety apparatus ECU 300 may provide a warning notification related to such strain on the lap harness sensor 134 and/or sash harness sensor 234, respectively, particularly within the transportation vehicle 10, to alert the driver and/or other vehicle occupants, which may include the seat occupant from which the warning arises, that the strain resulting from tension force F being placed on the lap harness sensor 134 and/or sash harness sensor 234 in a given lap harness 130 and/or sash harness 230 is not within a predetermined range of suitable strain limits, which is indicative of improper tension.

In addition, during vehicle use, seat safety apparatus 100, and more particularly lap harness sensor 134 and/or sash harness sensor 234, may be used to better ensure that the lap harness belt segment 132 and/or sash harness belt segment 232, respectively, are fitted properly to the seat occupant 20 with the requisite orientation (i.e. are not twisted). Once the lap harness 130 and/or sash harness 230 are properly buckled, such may be determined, for example, by the embodiment of FIG. 3B. With the embodiment of FIG. 3B, it may be understood that if the lap harness belt segment 132 and/or sash harness belt segment 232 is being used properly, the strain resulting from tension force F being placed on the two lap harness sensors 134 and/or sash harness sensors 234 should be substantially the same. However, if the strain resulting from tension force F being placed on the two lap harness sensors 134 and/or sash harness sensors 234 differs from each other more than a predetermined range, such would be indicative that the lap harness belt segment 132 and/or sash harness belt segment 232 is twisted.

If the seat safety apparatus ECU 300 determines that the strain resulting from tension force F being placed on the lap harness sensors 134 and/or sash harness sensors 234 differs from each other more than a predetermined range, the seat safety apparatus ECU 300 may provide a warning notification related to such strain on the lap harness sensor 34 and/or sash harness sensor 234, respectively, particularly within the transportation vehicle 10, to alert the driver and/or other vehicle occupants, which may include the seat occupant from which the warning arises, that the strain resulting from tension force F being placed on the lap harness sensors 134 and/or sash harness sensors 234 in a given lap harness 130 and/or sash harness 230 differs from each other more than a predetermined range, which is indicative of a twisted lap harness 130 and/or sash harness 230, respectively.

Furthermore, during vehicle use, seat safety apparatus 100, and more particularly lap harness sensor 134 and/or sash harness sensor 234, may be used to better ensure that the integrity of the lap harness belt segment 132 and/or sash harness belt segment 232, respectively, has not been compromised, such as through a vehicle collision or other substantial deceleration. As a result of a vehicle collision or other substantial deceleration, the integrity of the lap harness belt segment 132 and/or sash harness belt segment 232 may be compromised. For example, the fabric of the lap harness belt segment 132 and/or sash harness belt segment 232 may be weakened, due to the vehicle collision or other substantial deceleration event placing significant forces on the lap harness belt segment 132 and/or sash harness belt segment 232. The seat safety apparatus ECU 300 may be used to determine if the strain resulting from tension force F being placed on the lap harness sensor 134 and/or sash harness sensor 234 has exceeded a predetermined maximum threshold value as result of the vehicle collision or other deceleration.

If the seat safety apparatus ECU 300 determines that the strain resulting from tension force F being placed on the lap harness sensor 134 and/or sash harness sensor 234 has exceeded a predetermined maximum threshold value, the seat safety apparatus ECU 300 may provide a warning notification related to such strain on the lap harness sensor 134 and/or sash harness sensor 234, respectively, particularly within the transportation vehicle 10, to alert the driver and/or other vehicle occupants, which may include the seat occupant from which the warning arises, that the strain resulting from tension force F being placed on the lap harness sensor 134 and/or sash harness sensor 234 in a given lap harness 130 and/or sash harness 230 has exceeded a predetermined maximum threshold value, which is indicative that the integrity of the lap harness belt segment 132 and/or sash harness belt segment 232 may be compromised due to a vehicle collision or other deceleration.

In addition, during vehicle use, seat safety apparatus 100, and more particularly lap harness sensor 134 and/or sash harness sensor 234, may be used to better ensure that the integrity of the lap harness belt segment 132 and/or sash harness belt segment 232, respectively, has not been compromised, such as through wear and tear. As a result of wear and tear, the integrity of the lap harness belt segment 132 and/or sash harness belt segment 232 may be compromised. For example, the fabric of the lap harness belt segment 132 and/or sash harness belt segment 232 may be weakened, due to repeated use of the lap harness belt segment 132 and/or sash harness belt segment 232. The seat safety apparatus ECU 300 may be used to determine if the strain resulting from tension force F being placed on the lap harness sensor 134 and/or sash harness sensor 234 has exceeded a predetermined strain a predetermined number of times (occurrences) as a result of ongoing use.

If the seat safety apparatus ECU 300 determines that the strain resulting from tension force F being placed on the lap harness sensor 134 and/or sash harness sensor 234 has exceeded a predetermined strain a predetermined number of times (occurrences), the seat safety apparatus ECU 300 may provide a warning notification related to such strain on the lap harness sensor 134 and/or sash harness sensor 234, respectively, particularly within the transportation vehicle 10, to alert the driver and/or other vehicle occupants, which may include the seat occupant from which the warning arises, that the strain resulting from tension force F being placed on the lap harness sensor 134 and/or sash harness sensor 234 in a given lap harness 130 and/or sash harness 230 has exceeded a predetermined strain a predetermined number of times (occurrences), which is indicative that the integrity of the lap harness belt segment 132 and/or sash harness belt segment 232 may be compromised do to wear and tear.

Moreover, during vehicle use, seat safety apparatus 100, and more particularly lap harness sensor 134 and/or sash harness sensor 234, may be used to determine the severity of an impact force was placed upon a seat occupant during a vehicle collision or other deceleration. More particularly, the seat safety apparatus ECU 300 may be used to determine the strain resulting from tension force F being placed on the lap harness sensor 134 and/or sash harness sensor 234 during a vehicle collision or other deceleration, which may be understood to correlate to the force placed on the seat occupant 20. For example, the seat safety apparatus ECU 300 may be used to determine the strain resulting from tension force F being placed on the lap harness sensor 134 and/or sash harness sensor 234 during a vehicle collision or other deceleration corresponds to a low level, intermediate level or high level, which may be understood to correlate to the low, intermediate or high level of force placed on the seat occupant 20, respectively.

Furthermore, seat safety apparatus 100, and more particularly lap harness sensor 134 and/or sash harness sensor 234 being incorporated into lap harness 130 and sash harness 230 may be used to determine the severity of a vehicle collision or other vehicle deceleration as experienced by each seat occupant in a transportation vehicle. Because the magnitude and the effects of a vehicle collision or other vehicle deceleration may be expected to be different for each seat occupant (e.g. depending on the age, physical features, location in the car etc.) capturing this information using each seat harness 120 will be beneficial from a post collision or other deceleration event medical care perspective. By quickly identifying the physical damage each seat occupant may have experienced in a vehicle collision or other vehicle deceleration, and wirelessly sending this information to a remote hospital, a responding medical clinician may access critical initial insight into the medical state of each passenger before arriving at the vehicle scene. Such timely access can be critical to ensure the required medical intervention is delivered promptly to each casualty.

Moreover, seat safety apparatus 100, and more particularly lap harness sensor 134 and/or sash harness sensor 234 being incorporated into lap harness 130 and sash harness 230 may be used to determine whether a seat occupant is breathing. More particularly, the seat safety apparatus ECU 300 may be used to determine the strain resulting from tension force F being placed on the lap harness sensor 134 and/or sash harness sensor 234 over a period of time suitable to determine the breathing state of the seat occupant. For example, the seat safety apparatus ECU 300 may be used to determine the strain resulting from tension force F being placed on the lap harness sensor 134 and/or sash harness sensor 234 in a cyclic pattern, which may be understood to correspond with breathing in an out by the seat occupant. Moreover, the level of strain resulting from tension force F being placed on the lap harness sensor 134 and/or sash harness sensor 234 may be used to determine whether breathing by the seat occupant is deep or shallow to give an indication of medical condition after a vehicle collision or other deceleration. Conversely, a lack of such a cyclic pattern in the strain resulting from tension force F being placed on the lap harness sensor 134 and/or sash harness sensor 234 may be understood to be indicative of the seat occupant not breathing. Such information may be sent wirelessly to a medical clinician at a clinic to assist in the diagnosis of possible injuries.

The following examples pertain to further embodiments, from which numerous permutations and configurations will be apparent.

Example 1 discloses a seat harness comprising a lap harness, the lap harness comprising a lap harness belt segment and at least one lap harness sensor connected with the lap harness belt segment, the lap harness sensor formed of an electrically conductive material having an electrical resistance, the electrical resistance variable as a function of strain of the lap harness sensor wherein, in response to a change in strain of the electrically conductive material of the lap harness sensor, the electrical resistance of the electrically conductive material of the lap harness sensor changes, wherein the electrically conductive material of the lap harness sensor provides an electrical resistance in an electrical circuit of the seat safety apparatus, and wherein, in response to electrical power provided to the electrical circuit, the lap harness sensor provides a lap harness sensor output which changes as the electrical resistance of the electrically conductive material of the lap harness sensor changes.

Example 2 includes the subject matter of Example 1, and where the lap harness belt segment has a longitudinal length, the lap harness sensor extends longitudinally along the longitudinal length of the lap harness belt segment, and the lap harness sensor extends longitudinally along the longitudinal length of the lap harness belt segment solely along a medial longitudinal region of the lap harness belt segment such that opposing longitudinal end regions of the lap harness belt segment do not include the lap harness sensor.

Example 3 includes the subject matter of any of Examples 1-2, where the electrically conductive material of the lap harness sensor is mechanically and/or adhesively connected to the lap harness belt segment.

Example 4 includes the subject matter of any of Examples 1-2, where the lap harness belt segment comprises a woven fabric, and the electrically conductive material of the lap harness sensor comprises electrically conductive fibers which are woven into the woven fabric of the lap harness belt segment.

Example 5 includes the subject matter of any of Examples 1-2, where the electrically conductive material of the lap harness sensor comprises an electrically conductive coating applied to the lap harness belt segment.

Example 6 includes the subject matter of any of Examples 1-2, where the electrically conductive material of the lap harness sensor comprises a preformed electrically conductive strip which is mechanically and/or adhesively connected to the lap harness belt segment.

Example 7 includes the subject matter of any of Examples 1-2, where the electrically conductive material of the lap harness sensor comprises an electrically conductive fabric.

Example 8 includes the subject matter of Example 7, where the electrically conductive fabric is a knitted fabric.

Example 9 includes the subject matter of Example 8, where the knitted fabric comprises fibers formed of a plastic composition, wherein the plastic composition comprises a polyester-polyurethane copolymer and electrically conductive particles dispersed in the polyester-polyurethane copolymer.

Example 10 includes the subject matter of any of Examples 1-2, where the electrically conductive material of the lap harness sensor comprises an electrically conductive coating disposed on a resilient substrate.

Example 11 includes the subject matter of any of Examples 1-10 where the resilient substrate is a knitted fabric.

Example 12 includes the subject matter of any of Examples 1-11, where the lap harness sensor has opposing first and second longitudinal ends; the lap harness sensor extends longitudinally along the lap harness belt segment, the lap harness sensor and lap harness belt segment are connected at a first connection location adjacent the first longitudinal end of the lap harness sensor and a second connection location adjacent the second longitudinal end of the lap harness sensor, and where a longitudinal length of the lap harness sensor between the first and second connection locations is less than a longitudinal length of the lap harness belt segment between the first and second connection locations.

Example 13 includes the subject matter of any of Examples 1-12, where the seat harness further comprises a sash harness, the sash harness comprising a sash harness belt segment and at least one sash harness sensor connected with the sash harness belt segment, the sash harness sensor formed of an electrically conductive material having an electrical resistance, the electrical resistance variable as a function of strain of the sash harness sensor wherein, in response to a change in strain of the electrically conductive material of the sash harness sensor, the electrical resistance of the electrically conductive material of the sash harness sensor changes, wherein the electrically conductive material of the sash harness sensor provides an electrical resistance in an electrical circuit of the seat safety apparatus, and where, in response to electrical power provided to the electrical circuit, the sash harness sensor provides a sash harness sensor output which changes as the electrical resistance of the electrically conductive material of the sash harness sensor changes.

Example 14 includes the subject matter of any of Examples 1-13, further comprising a seat safety apparatus electronic control unit (ECU) electrically connected to the electrical circuit including the lap harness sensor, where the seat safety apparatus ECU is electrically connected with the lap harness sensor such that the lap harness sensor output is receivable by the seat safety apparatus ECU, and where, in response to the lap sensor output received by the seat safety apparatus ECU from the lap harness sensor, the seat safety apparatus ECU provides a warning notification related to strain on the lap harness sensor.

Example 15 includes the subject matter of Example 14, where the seat safety apparatus, including the lap harness and seat safety apparatus ECU, is operable with a seat in a transportation vehicle, and the warning notification related to strain on the lap harness sensor is provided by the seat safety apparatus ECU in response to strain on the lap harness sensor being outside a predetermined range of strain.

Example 16 includes the subject matter of Example 14, where the seat safety apparatus, including the lap harness and seat safety apparatus ECU, is operable with a seat in a transportation vehicle, and the warning notification related to strain on the lap harness sensor is provided by the seat safety apparatus ECU in response to strain on the lap harness sensor being greater than a maximum predetermined threshold value of strain.

Example 17 includes the subject matter of Examples 14, where the seat safety apparatus, including the lap harness and seat safety apparatus ECU, is operable with a seat in a transportation vehicle, and the warning notification related to strain on the lap harness sensor is provided by the seat safety apparatus ECU in response to strain on the lap harness sensor exceeding a predetermined strain a predetermined number of times.

Example 18 discloses a method of operating a seat safety apparatus, comprising providing a seat harness comprising a lap harness, the lap harness comprising a lap harness belt segment and at least one lap harness sensor connected with the lap harness belt segment, the lap harness sensor formed of an electrically conductive material having an electrical resistance, the electrical resistance variable as a function of strain of the lap harness sensor wherein, in response to a change in strain of the electrically conductive material of the lap harness sensor, the electrical resistance of the electrically conductive material of the lap harness sensor changes, where the electrically conductive material of the lap harness sensor is arranged as an electrical resistance in an electrical circuit of the seat safety apparatus, and where, in response to electrical power provided to the electrical circuit, the lap harness sensor provides a lap harness sensor output which changes as the electrical resistance of the electrically conductive material of the lap harness sensor changes, providing a seat safety apparatus electronic control unit (ECU) electrically connected to the electrical circuit including the lap harness sensor, wherein the seat safety apparatus ECU is electrically connected with the lap harness sensor such that the lap harness sensor output is receivable by the seat safety apparatus ECU, and where, in response to the lap sensor output received by the seat safety apparatus ECU from the lap harness sensor, the seat safety apparatus ECU provides a warning notification related to strain on the lap harness sensor.

Example 19 includes the subject matter of Example 18, further comprising, arranging the seat safety apparatus, including the lap harness and seat safety apparatus ECU, with a seat in a transportation vehicle, and providing the output warning notification from the ECU related to strain on the lap harness sensor in response to the lap harness sensor output received by the seat safety apparatus ECU from the lap harness sensor.

Example 20 includes the subject matter of Example 19, further comprising determining with the ECU that the lap harness sensor output received from the lap harness sensor corresponds to a strain on the lap harness sensor being outside a predetermined range of strain, and providing the output warning notification from the ECU related to strain on the lap harness sensor being outside the predetermined range of strain.

Example 21 includes the subject matter of Example 19, further comprising determining with the ECU that the lap harness sensor output received from the lap harness sensor corresponds to a strain on the lap harness sensor being greater than a maximum predetermined threshold value of strain, and providing the output warning notification from the ECU related to strain on the lap harness sensor being greater than the maximum predetermined threshold value of strain.

Example 22 includes the subject matter of Example 19, further comprising determining with the ECU that the lap harness sensor output received from the lap harness sensor corresponds to a strain on the lap harness sensor exceeding a predetermined strain a predetermined number of times, and providing the output warning notification from the ECU related to strain on the lap harness sensor exceeding the predetermined strain the predetermined number of times.

While a preferred embodiment of the present disclosure has been described, it should be understood that various changes, adaptations and modifications can be made therein without departing from the spirit of the disclosure and the scope of the appended claims. The scope of the disclosure should, therefore, be determined not with reference to the above description, but instead should be determined with reference to the appended claims along with their full scope of equivalents. Furthermore, it should be understood that the appended claims do not necessarily comprise the broadest scope of the disclosure which the applicant is entitled to claim, or the only manner(s) in which the disclosure may be claimed, or that all recited features are necessary.

What is claimed is:

1. A seat safety apparatus, comprising:
a seat harness comprising a lap harness, the lap harness comprising a lap harness belt segment and at least one lap harness sensor connected with the lap harness belt segment;
the lap harness sensor formed of an electrically conductive material having an electrical resistance, the electrical resistance variable as a function of strain of the lap harness sensor wherein, in response to a change in strain of the electrically conductive material of the lap harness sensor, the electrical resistance of the electrically conductive material of the lap harness sensor changes;
wherein the electrically conductive material of the lap harness sensor provides an electrical resistance in an electrical circuit of the seat safety apparatus; and
wherein, in response to electrical power provided to the electrical circuit, the lap harness sensor provides a lap harness sensor output which changes as the electrical resistance of the electrically conductive material of the lap harness sensor changes.

2. The seat safety apparatus of claim 1, wherein:
the lap harness belt segment has a longitudinal length;
the lap harness sensor extends longitudinally along the longitudinal length of the lap harness belt segment; and
the lap harness sensor extends longitudinally along the longitudinal length of the lap harness belt segment solely along a medial longitudinal region of the lap harness belt segment such that opposing longitudinal end regions of the lap harness belt segment do not include the lap harness sensor.

3. The seat safety apparatus of claim 1, wherein:
the electrically conductive material of the lap harness sensor is mechanically and/or adhesively connected to the lap harness belt segment.

4. The seat safety apparatus of claim 1, wherein:
the lap harness belt segment comprises a woven fabric; and
the electrically conductive material of the lap harness sensor comprises electrically conductive fibers which are woven into the woven fabric of the lap harness belt segment.

5. The seat safety apparatus of claim 1, wherein:
the electrically conductive material of the lap harness sensor comprises an electrically conductive coating applied to the lap harness belt segment.

6. The seat safety apparatus of claim 1, wherein:
the electrically conductive material of the lap harness sensor comprises a preformed electrically conductive strip which is mechanically and/or adhesively connected to the lap harness belt segment.

7. The seat safety apparatus of claim 1, wherein:
the electrically conductive material of the lap harness sensor comprises an electrically conductive fabric.

8. The seat safety apparatus of claim 7, wherein:
the electrically conductive fabric is a knitted fabric.

9. The seat safety apparatus of claim 8, wherein:
the knitted fabric comprises fibers formed of a plastic composition, wherein the plastic composition comprises a polyester-polyurethane copolymer and electrically conductive particles dispersed in the polyester-polyurethane copolymer.

10. The seat safety apparatus of claim 1, wherein:
the electrically conductive material of the lap harness sensor comprises an electrically conductive coating disposed on a resilient substrate.

11. The seat safety apparatus of claim 1, wherein:
the resilient substrate is a knitted fabric.

12. The seat safety apparatus of claim 1, wherein:
the lap harness sensor has opposing first and second longitudinal ends;
the lap harness sensor extends longitudinally along the lap harness belt segment;
the lap harness sensor and lap harness belt segment are connected at a first connection location adjacent the first longitudinal end of the lap harness sensor and a second connection location adjacent the second longitudinal end of the lap harness sensor; and
wherein a longitudinal length of the lap harness sensor between the first and second connection locations is less than a longitudinal length of the lap harness belt segment between the first and second connection locations.

13. The seat safety apparatus of claim 1, wherein:
the seat harness further comprises a sash harness, the sash harness comprising a sash harness belt segment and at least one sash harness sensor connected with the sash harness belt segment;
the sash harness sensor formed of an electrically conductive material having an electrical resistance, the electrical resistance variable as a function of strain of the sash harness sensor wherein, in response to a change in strain of the electrically conductive material of the sash harness sensor, the electrical resistance of the electrically conductive material of the sash harness sensor changes;
wherein the electrically conductive material of the sash harness sensor provides an electrical resistance in an electrical circuit of the seat safety apparatus; and
wherein, in response to electrical power provided to the electrical circuit, the sash harness sensor provides a sash harness sensor output which changes as the electrical resistance of the electrically conductive material of the sash harness sensor changes.

14. The seat safety apparatus of claim 1, further comprising:
a seat safety apparatus electronic control unit (ECU) electrically connected to the electrical circuit including the lap harness sensor;
wherein the seat safety apparatus ECU is electrically connected with the lap harness sensor such that the lap harness sensor output is receivable by the seat safety apparatus ECU; and
wherein, in response to the lap sensor output received by the seat safety apparatus ECU from the lap harness sensor, the seat safety apparatus ECU provides a warning notification related to strain on the lap harness sensor.

15. The seat safety apparatus of claim 14, wherein:
the seat safety apparatus, including the lap harness and seat safety apparatus ECU, is operable with a seat in a transportation vehicle; and
the warning notification related to strain on the lap harness sensor is provided by the seat safety apparatus ECU in response to strain on the lap harness sensor being outside a predetermined range of strain.

16. The seat safety apparatus of claim 14, wherein:
the seat safety apparatus, including the lap harness and seat safety apparatus ECU, is operable with a seat in a transportation vehicle; and
the warning notification related to strain on the lap harness sensor is provided by the seat safety apparatus ECU in response to strain on the lap harness sensor being greater than a maximum predetermined threshold value of strain.

17. The seat safety apparatus of claim 14, wherein:
the seat safety apparatus, including the lap harness and seat safety apparatus ECU, is operable with a seat in a transportation vehicle; and
the warning notification related to strain on the lap harness sensor is provided by the seat safety apparatus ECU in response to strain on the lap harness sensor exceeding a predetermined strain a predetermined number of times.

18. A method of operating a seat safety apparatus, comprising:
providing a seat harness comprising a lap harness, the lap harness comprising a lap harness belt segment and at least one lap harness sensor connected with the lap harness belt segment;
the lap harness sensor formed of an electrically conductive material having an electrical resistance, the electrical resistance variable as a function of strain of the lap harness sensor wherein, in response to a change in strain of the electrically conductive material of the lap harness sensor, the electrical resistance of the electrically conductive material of the lap harness sensor changes;
wherein the electrically conductive material of the lap harness sensor provides an electrical resistance in an electrical circuit of the seat safety apparatus; and
wherein, in response to electrical power provided to the electrical circuit, the lap harness sensor provides a lap harness sensor output which changes as the electrical resistance of the electrically conductive material of the lap harness sensor changes;
providing a seat safety apparatus electronic control unit (ECU) electrically connected to the electrical circuit including the lap harness sensor;
wherein the seat safety apparatus ECU is electrically connected with the lap harness sensor such that the lap harness sensor output is receivable by the seat safety apparatus ECU; and
wherein, in response to the lap sensor output received by the seat safety apparatus ECU from the lap harness sensor, the seat safety apparatus ECU provides a warning notification related to strain on the lap harness sensor.

19. The method of claim 18, further comprising:
arranging the seat safety apparatus, including the lap harness and seat safety apparatus ECU, with a seat in a transportation vehicle; and
providing the output warning notification from the ECU related to strain on the lap harness sensor in response to the lap harness sensor output received by the seat safety apparatus ECU from the lap harness sensor.

20. The method of claim 19, further comprising:
determining with the ECU that the lap harness sensor output received from the lap harness sensor corresponds to a strain on the lap harness sensor being outside a predetermined range of strain; and
providing the output warning notification from the ECU related to strain on the lap harness sensor being outside the predetermined range of strain.
